(19) United States
(12) Patent Application Publication
(10) Pub. No.: US 2006/0079264 A1
(43) Pub. Date: Apr. 13, 2006

(54) Outer loop power control of user equipment in wireless communication

(76) Inventors: Jian Gu, Guangdong (CN); Vinh Phan, Oulu (FI); Ramin Baghaie, Espoo (FI); Karri Ranta-Aho, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/988,435

(22) Filed: Nov. 12, 2004

Related U.S. Application Data
(63) Continuation-in-part of application No. 10/965,236, filed on Oct. 13, 2004.

(51) Int. Cl. H04B 1/00; H04B 7/00; H04Q 7/20

(52) U.S. Cl. 455/522; 455/69

(57) ABSTRACT

A faster power control method especially of use in case of a UE device communicating with a SAP (e.g. a Node B) of a UTRAN via E-DCH, where instead of the SAP (e.g. a Node B) receiving from the serving RNC a new SIR target to use because of changing channel conditions in what is called outer loop power control, the SAP instead receives a BLER target or a target value for some other indicator of channel quality (such as a new-data indicator value of EUPA) to use as a guide for determining, by itself, an appropriate SIR target.

### CROSS REFERENCE To RELATED APPLICATIONS

This application is a continuation-in-part of U.S. patent application Ser. No. 10/965,236 filed Oct. 13, 2004, from which priority is claimed under all applicable sections of Title 35 of the United States Code including, but not limited to, Sections 120, 121, and 365(c).

### BACKGROUND OF THE INVENTION

1. Technical Field

The present invention pertains to wireless transmission of data and voice via, for example, a third generation cellular communication network. In particular, the present invention relates to adjusting the power level of a transmitter in a user equipment device, such as a cellular handset.

2. Discussion of Related Art

The signal power output level of a user equipment (UE) device (e.g. a cellular handset) communicating via a cellular communication network is controlled by commands received from a service access point (SAP) (e.g. a Node B or base transceiver station) of the network. Efficient means of power control methods are required to minimize radio interference between UE devices that share common frequency bands. Ideally, in the uplink direction, all signals should arrive at the receiver of a SAP with the same signal intensity. Therefore, the output power level of a UE device is constantly adjusted. The devices far from the SAP should transmit with considerably higher power than the devices close to the SAP.

There are two basic types of power control: open-loop and closed-loop. In open-loop power control, the UE device sets its output power to a value it chooses; open-loop power control is used for setting initial uplink and downlink transmission power when a UE device accesses the network. In closed-loop power control, the SAP measures the quality of the transmission from a UE device, and then sends power control commands to UE device, adjusting the transmission power used by the UE device, and so adjusting the quality of the transmission from the UE device.

In the third generation (3G) cellular system UMTS (Universal Mobile Telecommunication System) including a so-called UTRAN (UMTS Terrestrial Radio Access Network) which in turn includes a SAP for communicating with a UE device, the uplink closed-loop power control includes an inner loop power control (ILPC) and an outer loop power control (OLPC). In the former, the UE transmitter adjusts its output power in accordance with one or more transmit power control commands received from the SAP in order to maintain the uplink Signal-to-Interference Ratio (SIR) at a given SIR target, with the uplink SIR as measured by the SAP. The UTRAN typically includes—for each cell site—one or more SAPs all under the control of a Radio Network Controller (RNC), which in turn is controlled by the so-called core network (that ultimately connects to the Public Switched Telephone System), and in OLPC, the RNC adjusts the SIR target according to the uplink channel quality, which the RNC determines based on information provided by the SAP. Normally, the target SIR is updated for each UE device independently, according to a BLock Error Rate (BLER) value, a Bit Error Rate (BER) value, or some other indicator of channel quality.

It is known in the art that for the uplink (UL) dedicated channel (DCH), in OLPC in UTRAN-FDD (Frequency Division Duplex) the RNC updates the SIR target stored in the SAP for each UL channel. The SAP administers the OLPC by comparing the SIR for the uplink signal with the SIR target and sending power control commands to the UE device in order to maintain the received SIR as close to the SIR target as possible. This OLPC mechanism relies on the RNC adjusting the SIR target based on received BLER statistics of the estimated connection quality. Such OLPC is a relatively slow control mechanism. FIG. 1 illustrates prior art uplink power control for a connection via the DCH between a UE device 10 and a SAP 11, where the RNC 12 controlling the SAP updates the SIR target for the uplink DCH according to a measured BLER or other indicator of quality of that channel. The SAP then runs the closed-loop power control and tries to maintain the SIR of the received signal as close to the SIR target as possible.

In the so-called 3G Partnership Project (3GPP), which specifies UMTS, a current task is to specify enhanced DCH (E-DCH) support. The E-DCH is intended to provide improved UL packet access in UTRAN-FDD using dedicated transport channels, and for that, a more efficient OLPC mechanism is required. This is because the data transfer rate of the E-DCH connection may vary frequently and in a large dynamic range. Therefore, the current OLPC in use with the existing DCH may not always function efficiently for the E-DCH.

It is also noted that the uplink OLPC of the prior art is implemented in the RNC because, for one thing, uplink can be in soft handover and only the RNC has the information about the multiple links of a handover UE. But there is a long transmission delay between an RNC and a SAP, typically hundreds of milliseconds. Therefore, the long delay prohibits OLPC utilizing real-time information, such as fading information and also HARQ information (i.e. whether there has been a packet error, indicating that perhaps higher power is needed). Thus, in some applications it is advantageous to be able to make use of HARQ information for OLPC.

Since OLPC can directly affect overall system capacity, performance and coverage, it would be advantageous to have a fast and efficient OLPC method for E-DCH.

### DISCLOSURE OF INVENTION

In a first embodiment of the invention, a method is provided, comprising: a step in which a service access point (SAP) of a radio access network (RAN) determines a new signal-to-interference ratio (SIR) target corresponding to an indicator of channel quality by comparing a target value for the indicator of channel quality with a measured value for the indicator of channel quality; and a step in which the SAP uses the SIR target to provide power control commands to a user equipment device providing an uplink signal.

In accord with the first aspect of the invention, the indicator of channel quality may be a block error rate (BLER) measured before any HARQ processing.

Also in accord with the first aspect of the invention, the indicator of channel quality may be a block error rate (BLER) and may be measured after HARQ processing using a new-data indicator indicating whether a transmission includes a retransmission.

Also in accord with the first aspect of the invention, the SAP may use a plurality of SIR targets each corresponding to a different data transfer rate, and the method may further comprise a step in which the SAP detects the data transfer rate and then selects a SIR target from the plurality of SIR targets based on the detected data transfer rate. Further, the method may also include the step of tuning one or more of the plurality of SIR targets based on comparing the target indicator of channel quality with the measured value for the indicator of channel quality.

Also in accord with the first aspect of the invention, the RAN may include a radio network controller (RNC) for connecting the SAP to a core network of a telecommunication system, and the RNC may provide the target indicator of channel quality.

In a second aspect of the invention, a computer program product is provided comprising a computer readable storage structure embodying computer program instructions thereon, by which a computer processor is enabled to perform the steps of a method including: a step in which a service access point (SAP) of a radio access network (RAN) determines a new signal-to-interference ratio (SIR) target corresponding to an indicator of channel quality by comparing a target value for the indicator of channel quality with a measured value for the indicator of channel quality; and a step in which the SAP uses the SIR target to provide power control commands to a user equipment device providing an uplink signal.

In a third aspect of the invention, a service access point (SAP) of a radio access network (RAN) is provided, comprising: means by which the SAP determines a new signal-to-interference ratio (SIR) target corresponding to an indicator of channel quality by comparing a target value for the indicator of channel quality with a measured value for the indicator of channel quality; and means by which the SAP uses the SIR target to provide power control commands to a user equipment device providing an uplink signal.

In a fourth aspect of the invention, a system is provided, comprising: a user equipment (UE) device, for providing an unlink signal, and responsive to a power control command; and a radio access network (RAN), for coupling the user equipment device to a core network, the RAN including: a service access point (SAP), responsive to the uplink signal, for providing the power control command; and a radio network controller, for providing a block error rate (BLER) target or other indicator of channel quality; wherein the SAP comprises: means by which the SAP determines a signal-to-interference ratio (SIR) target corresponding to an indicator of channel quality by comparing a target value for the indicator of channel quality with a measured value for the indicator of channel quality; and means by which the SAP obtains a measured SIR value for the uplink signal and uses the SIR target to provide power control commands to the UE device by comparing the measured SIR value to the SIR target.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram illustrating a system in which uplink power control for the uplink DCH connecting a UE device with a SAP is performed according to the prior art.

FIG. 2A is a block diagram of initial setup and subsequent closed-loop power control according to an embodiment of the invention in which a BLER is determined before HARQ processing.

FIG. 2B is a block diagram of initial setup and subsequent closed-loop power control according to an embodiment of the invention in which a BLER is determined after HARQ processing.

FIG. 3 is a schematic illustration of timing for EUPA in case of the embodiment of the invention in which a BLER is determined after HARQ processing.

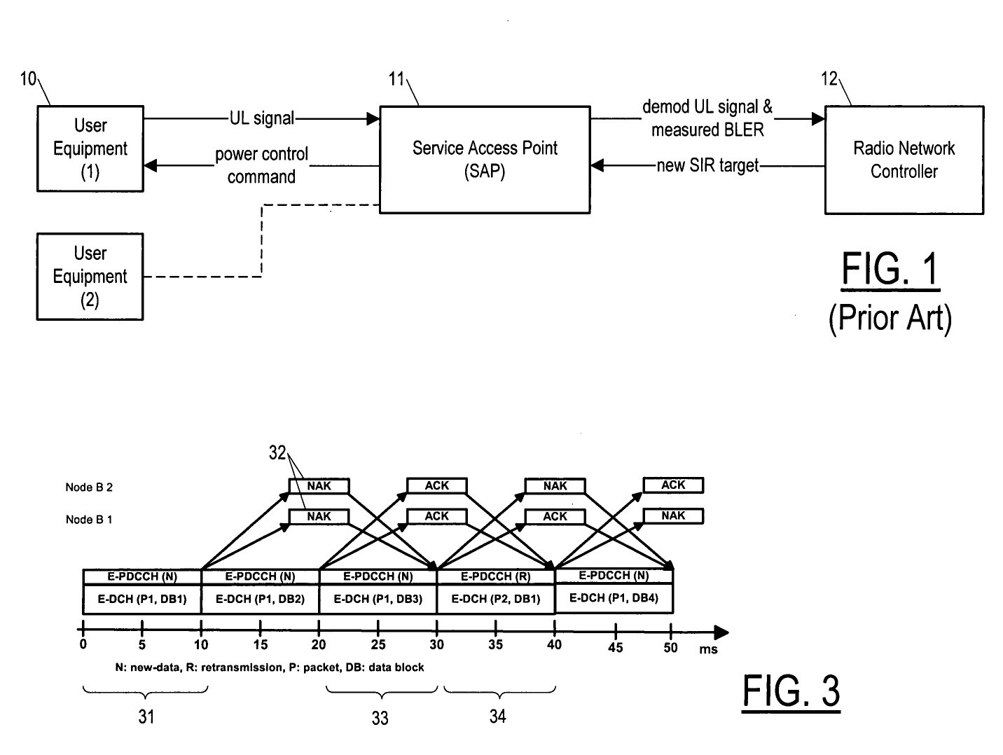

### BEST MODE FOR CARRYING OUT THE INVENTION

The invention is described below in case of a UE device communicating with a SAP via a E-DCH communication channel. However, the invention is in no way limited to use of E-DCH, but is instead of use for communication in any system including a UE device receiving power control commands from a SAP for wireless communication with the SAP.

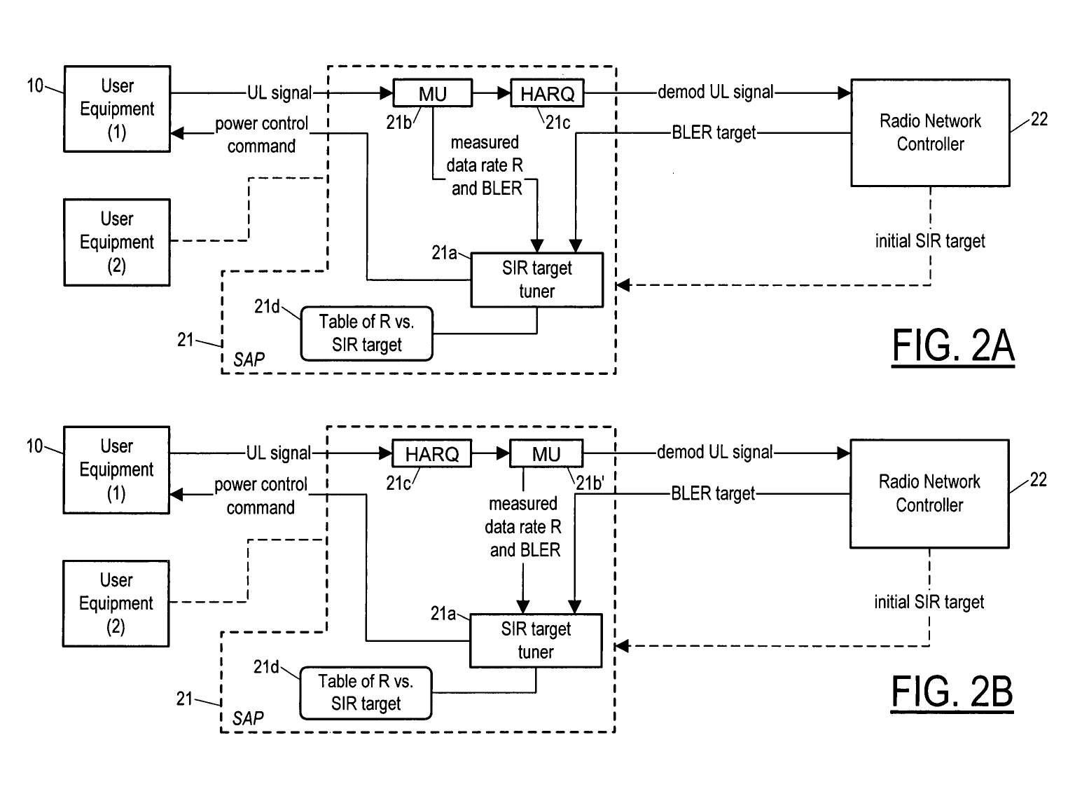

Referring now to FIG. 2A, according to the present invention, at the setup of a connection from a UE device 10 to a SAP 21 under the control of a RNC 22 of a UTRAN, the SAP receives from the UE device an uplink signal having a certain signal to interference ratio (SIR) and data transfer rate R. Now according to the invention, a SIR target tuner module 21a of the SAP receives from the RNC 22 a target value for an indicator of channel quality, an indicator such as the BLER (or possibly a new-data indicator, as explained below), and determines a new SIR target corresponding to the target indicator of channel quality (e.g. a BLER target). Taking a BLER target as an example of a target indicator of channel quality, the SAP determines a new SIR target by comparing the target BLER with a measured uplink BLER value. In the embodiment shown in FIG. 2A, the uplink BLER is measured by a measuring unit (MU) 21b before any HARQ functionality 21c. (OLPC and estimating BLER are continuous procedures.

Referring now to FIG. 2B, in another embodiment of the invention the BLER is measured by a MU 21b′ caused to execute after HARQ processing, and in fact uses information provided by the HARQ processing to determine the BLER value. In either the embodiment shown in FIG. 2A or 2B, the MU does not necessarily measure a BLER value directly from a link signal, but instead estimates a BLER value from any available results of processing the link signal, including decoding results. Thus, in the embodiment of FIG. 2B, the MU actually uses a new-data indicator—as explained in more detail below—made available by HARQ processing; the HARQ processing decodes at least the component of the link signal so as to provide the new-data indicator, which can be used to estimate a BLER value.

Thus, in some embodiments (FIG. 2A) the MU 21b providing a BLER value is placed before any HARQ processing, while in other embodiments (FIG. 2B), the MU 21b′ providing a BLER value uses information from HARQ processing to determine the BLER value and so is placed after such HARQ processing.

Also in either embodiments (FIGS. 2A and 2B), by comparing the measured and target BLER values, the SAP self-adjusts the SIR target it uses for OLPC, rather than receiving a new SIR target from the RNC, as is done according to conventional OLPC procedures. The adjustment made to the SIR target by the SAP according to the invention is based on the difference between the BLER target and the measured uplink BLER value; if the BLER value is less than the BLER target, the SIR target is decreased. The SAP uses the new SIR target to provide power control commands to the UE device. (The measured BLER value—measured before or after HARQ processing—takes into account both the channel conditions and the distance of the UE device from the SAP.)

In case of the E-DCH, the data rate can vary quickly, and the invention further provides that the SAP uses a possibly different SIR target for each of several data transfer rates, with each SIR target corresponding to the same BLER target. In such embodiments, the SAP determines a SIR target to use for power control based on a measured value of the uplink data transfer rate. FIG. 2 shows such an embodiment, where the SAP using a table 21d of rate R versus SIR target values. The SAP detects the rate R and, if the rate has changed, selects a from the table 21d a possibly new SIR target corresponding to the detected rate R.

In case of using a table providing SIR targets for different data transfer rates, when tuning the SIR target for the data rate in use by the UE device, the SAP may or may not also tune the SIR targets for the other data rates. Since the SIR target for the data rate in use is tuned because channel conditions have changed (deteriorated or improved), it is reasonable to change the SIR targets not only for the data rate in use, but also for the other data rates, since the channel conditions are to some extent independent of the data rate. However, it may be that for some data rates—especially lower data rates—the default or starting value of the SIR target should be used as the starting point for tuning, or the last tuned-to value.

The SAP could use different BLER target values at different times, or even for different data transfer rates or different services. One or another of the BLER target values could be provided by other means than the RNC. For example, an operation and maintenance function (O&M) could provide one or another of the BLER targets to be used by the SAP.

In the embodiment of the invention illustrated in FIG. 2B, advantageous especially in case of (Wideband Code Division Multiple Access) EUPA (Enhance Uplink Packet Access) of UMTS, HARQ information is used in essence as the indicator of channel quality; more specifically, a measured BLER value is determined using HARQ information. Synchronous HARQ is used in WCDMA EUPA. For an EUPA link having M SAW (Stop-And-Wait) channels, a HARQ retransmission is sent M−1 TTIs (transmission time intervals) after the most recent previous transmission if the terminal receives NAK(s) for the most recent previous transmission from the Node B(s) in its active set. According to the invention, a SAP uses a new-data indicator conveyed in EUPA on E-PDCCH (enhanced physical dedicated control channel) to determine a measured BLER value, which is then again the measured value of the indicator of channel quality. As in the embodiment of FIG. 2A, the measured BLER and a target BLER are compared in deciding how to adjust the SIR target used in OLPC.

In using the new-data indicator, the decoding of all SAPs (Node Bs in UMTS) in the SHO (soft handover) active set of a UE device (mobile station) should be used. Each SAP can know the decoding of the i^{th} TTI at all SAPs in the SHO active set of the UE by detecting whether a new data block or a retransmitted data block is conveyed in the (i+M)^{th} TTI. A retransmitted data block detected by the SAP in the (i+M)^{th} TTI indicates all SAPs did not correctly receive the i^{th} TTI. As explained, the information indicating whether a new or retransmitted data block is conveyed in the (i+M)^{th} TTI is embedded in a new-data indicator of E-PDCCH. According to the invention, the BLER of the j^{th} HARQ transmission is updated by detecting the new-data indicator for the (i+M)^{th} TTI, where the j^{th} HARQ transmission of a packet is received in the i^{th} TTI. Thus, the SIR target is adjusted based on the BLER of different HARQ transmissions, i.e. based on the new-data indicator.

Thus, and now referring to FIG. 3, an example is shown there for M=3 (i.e. 3 SAW channels) in which OLPC works according to N (new data) or R (retransmission) in E-PDCCH. In a first TTI 31 (0-10 ms), P1 in DB1 is conveyed (on E-DCH) along with a new-data indicator (on E-PDCCH) indicating new data (as opposed to a retransmission). Node B1 and also Node B2 both reply with a NAK 32, which is not received until the third TTI 33. Then in the 4th TTI 34, DB1 is retransmitted. According to the invention, the new-data indicator in the fourth TTI 34 is used to estimate a BLER that can be compared with a target value, and, depending on the comparison, tune the SIR target used for OLPC.

The invention can simplify the implementation of EUPA Node B and RNC, i.e., no OLPC signaling is necessary between Node B and RNC.

ACK/NAK feedback error has a negligible impact on a method according to the invention because in practice the error rate of ACK/NAK is very low, typically 1% for ACK and 0.1% for NAK.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which a service access point (SAP) of a radio access network (RAN) determines a new signal-to-interference ratio (SIR) target corresponding to an indicator of channel quality by comparing a target value for the indicator of channel quality with a measured value for the indicator of channel quality; and
a step in which the SAP uses the SIR target to provide power control commands to a user equipment device providing an uplink signal.

2. A method as in claim 1, wherein the indicator of channel quality is a block error rate (BLER) measured before any HARQ processing.

3. A method as in claim 1, wherein the indicator of channel quality is a block error rate (BLER) and is measured after HARQ processing using a new-data indicator indicating whether a transmission includes a retransmission.

4. A method as in claim 1, wherein the SAP uses a plurality of SIR targets wherein each SIR target corresponds to a different data transfer rate, and the method further comprises a step in which the SAP detects the data transfer rate and then selects a SIR target from the plurality of SIR targets based on the detected data transfer rate.

5. A method as in claim 4, further comprising a step of tuning one or more of the plurality of SIR targets based on comparing the target indicator of channel quality with the measured value for the indicator of channel quality.

6. A method as in claim 1, wherein the RAN includes a radio network controller (RNC) for connecting the SAP to a core network of a telecommunication system, and the RNC provides the target indicator of channel quality.

7. A computer program product comprising a computer readable storage structure embodying computer program instructions thereon, by which a computer processor is enabled to perform the steps of a method including:
a step in which a service access point (SAP) of a radio access network (RAN) determines a new signal-to-interference ratio (SIR) target corresponding to an indicator of channel quality by comparing a target value for the indicator of channel quality with a measured value for the indicator of channel quality; and
a step in which the SAP uses the SIR target to provide power control commands to a user equipment device providing an uplink signal.

8. A computer program product as in claim 7, wherein the indicator of channel-quality is a block error rate (BLER) and is measured before any HARQ processing.

9. A computer program product as in claim 7, wherein the indicator of channel quality is a block error rate (BLER) and is measured after HARQ processing using a new-data indicator indicating whether a transmission includes a retransmission.

10. A computer program product as in claim 7, further comprising computer program code for causing the SAP to perform a step in which the SAP detects the data transfer rate and then selects a SIR target from a plurality of SIR targets based on the detected data transfer rate.

11. A service access point (SAP) of a radio access network (RAN), comprising:
means by which the SAP determines a new signal-to-interference ratio (SIR) target corresponding to an indicator of channel quality by comparing a target value for the indicator of channel quality with a measured value for the indicator of channel quality; and
means by which the SAP uses the SIR target to provide power control commands to a user equipment device providing an uplink signal.

12. A SAP as in claim 11, wherein the indicator of channel quality is a block error rate (BLER) measured before any HARQ processing.

13. A SAP as in claim 11, wherein the indicator of channel quality is a block error rate (BLER) and is measured after HARQ processing using a new-data indicator indicating whether a transmission includes a retransmission.

14. A SAP as in claim 11, further comprising means by which the SAP detects the data transfer rate and then selects a SIR target from a plurality of SIR targets based on the detected data transfer rate.

15. A SAP as in claim 11, further comprising the means for tuning one or more of the plurality of SIR targets based on comparing the target indicator of channel quality with the measured value for the indicator of channel quality.

16. A system, comprising:
a user equipment (UE) device, for providing an unlink signal, and responsive to a power control command; and
a radio access network (RAN), for coupling the user equipment device to a core network, the RAN including:
a service access point (SAP), responsive to the uplink signal, for providing the power control command; and
a radio network controller, for providing a block error rate (BLER) target or other indicator of channel quality;
wherein the SAP comprises:
means by which the SAP determines a signal-to-interference ratio (SIR) target corresponding to an indicator of channel quality by comparing a target value for the indicator of channel quality with a measured value for the indicator of channel quality; and
means by which the SAP obtains a measured SIR value for the uplink signal and uses the SIR target to provide power is control commands to the UE device by comparing the measured SIR value to the SIR target.

17. A system as in claim 16, wherein the indicator of channel quality is a block error rate (BLER) measured before any HARQ processing.

18. A system as in claim 16, wherein the indicator of channel quality is a block error rate (BLER) and is measured after HARQ processing using a new-data indicator indicating whether a transmission includes a retransmission.
